(19) United States
(12) Patent Application Publication
(10) Pub. No.: US 2008/0011871 A1
(43) Pub. Date: Jan. 17, 2008

(54) Dispenser

(75) Inventor: Stephen Sexton, Corinda (AU)

Correspondence Address: DAVID P DURESKA;BUCKINGHAM DOOLITTLE & BURROUGHS, LLP, 4518 FULTON DRIVE, NW, P O BOX 35548, CANTON, OH, 44735-5548, US

(73) Assignee: Bioglobal Limited, Queensland (AU)

(21) Appl. No.: 11/576,769

(22) PCT Filed: Oct. 6, 2005
(86) PCT No.: PCT/AU05/01536

§ 371 Date: Sep. 12, 2007

(30) Foreign Application Priority Data
Oct. 6, 2004 (AU) 2004905757

(51) Int. Cl. A01M 1/02; A01N 25/34

(52) U.S. Cl. 239/55

(57) ABSTRACT

A dispenser for a controlled release of a volatile material, the dispenser including a pair of walls permeable to the volatile material attached to, or integral with, each other at a periphery of the dispenser wherein the pair of walls of the dispenser are separated by a small gap of about 5 to 1000 microns which surrounds an internal reservoir containing the volatile material. The volatile material may be a semiochemical, pheromone, kairomone, allomone, perfume, fragrance, insecticide, antibacterial agent, antifungal agent, plant growth regulator, plant hormone or essential oil.

### FIELD OF INVENTION

This invention relates to a device that allows controlled release of volatile materials. In particular, but not exclusively, the invention relates to a dispenser that allows controlled and sustained release of fragrances and agricultural pest control agents.

### BACKGROUND OF THE INVENTION

Volatile hydrophobic semiochemicals, such as pheromones, kairomones and allomones are used to control arthropod pests, such as insects. Natural and synthetic semiochemicals attract, repel and otherwise influence the behaviour of insects. For example, synthetic sex pheromones of Lepidoptera, have been used successfully to control moth pests of crops. The pheromones disrupt communication between male and female moths which prevents or delays mating. Subsequently, fertile eggs are not laid and damage to crops caused by caterpillars hatching from the eggs is prevented.

There are many methods of presentation and formulation of semiochemicals including discrete dispensers and sprays comprising microencapsulated semiochemicals. Semiochemicals are generally volatile, labile in the environment and expensive to manufacture. As a consequence, a semiochemical dispenser or device is required that limits and/or controls the rate of evaporation of the semiochemical over a long period of time, and protects the semiochemical from oxidation and degradation by sunlight.

Ideally the semiochemicals are released at a constant rate and continuous manner to be effective over a significant period of time throughout the crop field or orchard. However, conventional formulations containing such semiochemicals have various disadvantages as described in more detail below.

Temperature affects the rate of evaporation of semiochemicals. In field conditions, temperatures vary according to the time of day and the time of year. Inadequately designed dispensers can waste semiochemicals by allowing excessive evaporation during the hottest hours of the day and releasing an inadequate amount in the cooler hours.

There are two types of prior art dispensers, those comprising a matrix system and those comprising a reservoir system.

Matrix system dispensers are dispensers in which an active ingredient, such as a semiochemical, is dissolved in or dispersed evenly through a polymeric matrix. They are easy and inexpensive to manufacture. However, the disadvantage of a matrix system is that the rate of release of the semiochemical from the matrix is dependent on the concentration of semiochemical in the matrix. The release rate is non-linear and decreases over time. This results in wastage of semiochemical early in the dispenser's life and inadequate release in the latter part. Therefore matrix system dispensers are generally inefficient.

Reservoir system dispensers are more difficult to manufacture but can release a semiochemical, for example a pheromone, at a constant rate, i.e. can achieve zero order release. Therefore reservoir system dispensers now dominate the market.

The most common prior art reservoir system is a polyethylene dispenser in tube form as described in U.S. Pat. No. 4,600,146, in the name of Ohno, and U.S. Pat. No. 4,734,281, in the name of Yamamoto et al. The disadvantage of the polyethylene tube dispensers is the dependence of the rate of release of the pheromone on the particular level or amount of pheromone in the tube dispenser. As the level of the pheromone recedes, there is a decrease in the rate of release of the pheromone with time resulting in non-linear release of pheromone from the dispenser.

Film bag reservoir systems are also commonly used as pheromone dispensers. The systems generally have a large evaporation surface of greater than 30 cm². Therefore the diffusion rate of the pheromone must be decreased or slowed to control the rate of release of the pheromone. In European Patent No. 0194896 the pheromones are dissolved in alcohol to reduce the diffusion rate of the pheromone through the film bag. In European Patent No. 0342126 the pheromone diffusion rate is slowed by the use of laminated films.

U.S. Pat. No. 6,159,489, in the name of Research Association for Biotechnology of Agricultural Chemicals, describes tubular and bag-type pheromone dispensers. The bag-type pheromone dispensers can be made of aliphatic polyester films and have a sustained release area of at least 1 cm² and a thickness of at least 0.2 mm.

The disadvantages of film bag reservoir systems are as follows: (i) the rate of pheromone release is not constant or reproducible and the dispenser releases pheromone rapidly in hot conditions during the day, when the target pests (crepuscular and nocturnal moths) are inactive, and less pheromone at night when the pests are active; (ii) the film bags tend to inflate in strong sunlight and can split open; (iii) difficulties are encountered when attaching or suspending the film bags to trees as it is necessary to punch a hole in the bag, pass a cord or wire through the hole and tie it to a branch which is a time consuming exercise; and (iv) the film bags can be easily destroyed by automatic harvesting machines since the bags are labile and therefore fragile.

U.S. Pat. No. 4,834,745, in the name of Shin-Etsu Chemical Co., describes a pheromone dispenser having a spherical, cylindrical or plate-like form made of a polymeric material. The dispenser is sufficiently large to contain at least a 100 mg of a pheromone and the pheromone is released from an outer surface of the dispenser in the form of a vapour. The ratio of the outer surface area of the dispenser to the amount of sex pheromone contained in the dispenser falls in the range from 4 to 11. Therefore, this dispenser is essentially a tube dispenser, as described above in U.S. Pat. Nos. 4,600,146 and 4,734,281. Tube dispensers are limited in regard to their flexibility in relation to manufacture of the dispensers and in relation to loading of the dispensers with active ingredients.

### SUMMARY OF INVENTION

It is an object of the invention to provide a dispenser for a volatile material, such as a semiochemical or fragrance, that alleviates the disadvantages of the prior art. Unexpectedly, the inventors have ascertained that a dispenser having permeable walls that are arranged in extremely close proximity, i.e. spaced by a gap of 5 to 1000 microns may be used as an effective dispenser for such materials. The dispenser provides prolonged field life or operational longevity of the volatile materials.

In one form, although it need not be the only or indeed the broadest form, the invention resides in a dispenser for controlled release of a volatile material, the dispenser including a pair of walls permeable to the volatile material attached to, or integral with, each other at a periphery of the dispenser wherein the pair of walls of the dispenser are separated by a small gap of about 5 to 1000 microns which surrounds an internal reservoir containing the volatile material.

Preferably, the pair of walls are separated by a small gap of about 40 to 200 microns.

The provision of two adjacent walls of permeable material enables the provision of a dispenser which may have relatively limited capacity, i.e. 50 to 5000 microlitres, and ensures the internal surfaces of the walls remain in contact with the volatile material inside the dispenser. The volatile material is drawn over the internal surfaces of the walls of the dispenser from the well or reservoir by capillary action resulting from the close proximity of the internal surfaces. The walls preferably have a thickness of 250 to 2000 microns and are preferably made of a polymer permeable to the volatile material.

More preferably, the walls have a thickness of 700 to 1000 microns.

The internal reservoir may have a radially ribbed or corrugated internal surface to facilitate movement or spread of the volatile material located within the reservoir throughout a hollow interior or internal space of the dispenser.

The volatile material can include any volatile compound such as a semiochemical, pheromone, kairomone, allomone, perfume or fragrance.

The dispenser may also comprise a peripheral well within the dispenser located around the perimeter of the dispenser which prevents spread of the volatile material to the perimeter of the dispenser.

Preferably, the dispenser is planar and may have any suitable shape but preferably is substantially circular, square or rectangular.

One or a plurality of volatile materials may be inserted within the dispenser. Suitably, a volatile material may be admixed with an anti-oxidant, ultraviolet stabilizer and diluent prior to insertion into the dispenser. Suitable anti-oxidants include butylated hydroxy toluene, butylated hydroxy anisole, vitamin E and vitamin E acetate.

Preferably, the polymer from which the dispenser is made contains pigments selected from the group consisting of carbon black, titanium dioxide, ferric oxide and zinc oxide which serve to protect the contents of the dispenser from degradation by sunlight. Similarly, the polymer may contain UV stabilizers, such as benzophenones and benzotriaziles.

The dispenser can be used for the protection of crops, fruit, trees and plants from arthropod pests. This invention is particularly useful for the control of flying insect pests such as moths, flies, beetles and wasps.

The dispenser may be used for controlled release of fragrances for air freshening of rooms and cars.

The dispenser may be used for controlled release of volatile plant hormones or plant growth regulators for influencing plant processes to enhance resistance to insect pests or improve colour in fruit and other such processes. Suitable plant hormones include methyl salicylate, methyl jasmonate or cis-jasmone.

The dispenser may also be used for controlled release of volatile antifungal or antibacterial compounds such as cinnamaldehyde, anisaldehyde, thymol and carvacrol.

The dispenser may also have an attachment or suspension means that allows the dispenser to be attached to, or suspended from, the limbs of trees, bushes, vines, crops, wires, string, stakes and other support structures.

suspended to a support structure.

Preferably, the attachment or suspension means includes a body and a dispenser attachment means.

Preferably, the attachment or suspension means includes a clip having a pair of resilient arms spaced from each other by a narrow slot.

Preferably, the body has a planar or sheet-like shape and is comprised of a rigid material which comprises at least one fugitive dye or pigment which changes in is colour under prolonged exposure to sunlight. The rigid material is preferably a rigid polymer.

The dispenser may be incorporated into the attachment or suspension body by snap fit, interference fit or plug-socket interaction.

The body may also include a holding clip having associated therewith an attachment aperture whereby the holding clip provides access to the attachment aperture for insertion thereof of a branch of a tree, for example.

Throughout this specification, “comprise”, “comprises” and “comprising” are used inclusively rather than exclusively, will be understood to imply the inclusion of a stated integer or group of integers but not the exclusion of any other integer or group of integers.

### BRIEF DESCRIPTION OF THE DRAWINGS

Reference may now be made to a preferred dispenser of the invention as shown in the attached drawings wherein:

FIG. 1 is a cross sectional view of a first embodiment of the dispenser;

FIG. 2 is a plan view of an internal surface of a bottom wall of the dispenser;

FIG. 3 is a plan view of the attachment or suspension means comprising the dispenser;

FIG. 4 is a cross sectional side view of the attachment or suspension means comprising a dispenser;

FIG. 5 is a plan view of a dispenser and clip of a second embodiment of the invention;

FIG. 6 is a cross sectional view of a dispenser and clip taken through A-A in is FIG. 5;

FIG. 7 is a perspective view of a dispenser and clip of the second embodiment;

FIG. 8 provides a plan and perspective view of an empty dispenser of the second embodiment in an open configuration;

FIG. 9 provides a plan and perspective view of the dispenser of FIG. 8 wherein a reservoir of the dispenser has been filled with a volatile material;

FIG. 10 provides a plan and perspective view of the dispenser of FIG. 9 being closed.

FIG. 11 provides a plan and perspective view of the dispenser of FIG. 10 in a closed configuration;

FIG. 12 provides a plan and perspective view of the dispenser of FIG. 11 being attached to a clip;

FIG. 13 show plan and perspective views of the dispenser of FIG. 12 attached to the clip;

FIG. 14 shows a graph of data obtained from Experiment 1 of Example 4 showing the release rate of volatile material from dispensers having walls of varying thickness;

FIG. 15 shows a graph of data obtained from Experiment 2 of Example 4 showing the release rate of volatile material from dispensers having walls of varying thickness;

FIG. 16 shows a graph of data obtained from Experiment 3 of Example 4 showing the release rate of volatile material from dispensers made from varying ratios of EVA and low density polyethylene;

FIG. 17 shows a graph of data obtained from Experiment 4 of Example 4 showing the release rate of volatile material from dispensers made from varying ratios of EVA and low density polyethylene;

FIG. 18 shows a graph of data obtained from Experiment 5 of Example 4 showing the release rate of volatile material from dispensers made from EVA 660 and EVA 750 having walls of varying thickness;

FIG. 19 shows a graph of data obtained from Experiment 6 of Example 4 showing the release rate of volatile material from dispensers made form high density polyethylene having walls of varying thickness;

FIG. 20 shows a graph of data obtained from Experiment 7 of Example 4 showing the release rate of volatile material from dispensers made from varying ratios of high density polyethylene and low density polyethylene; and

FIG. 21 shows a graph of data obtained from Experiment 8 of Example 4 showing the release rate of volatile material from dispensers made from varying ratios of high density polyethylene and low density polyethylene having walls of varying thickness.

### DETAILED DESCRIPTION OF INVENTION

For the purposes of this invention, by “volatile material” is meant any material in liquid or solid form that can vaporize or evaporate into the atmosphere.

By “semiochemical” is meant a biologically active volatile compound that affects the behavior of arthropods and other organisms and includes pheromones, kairomones and allomones. Such semiochemicals may function as pest control agents.

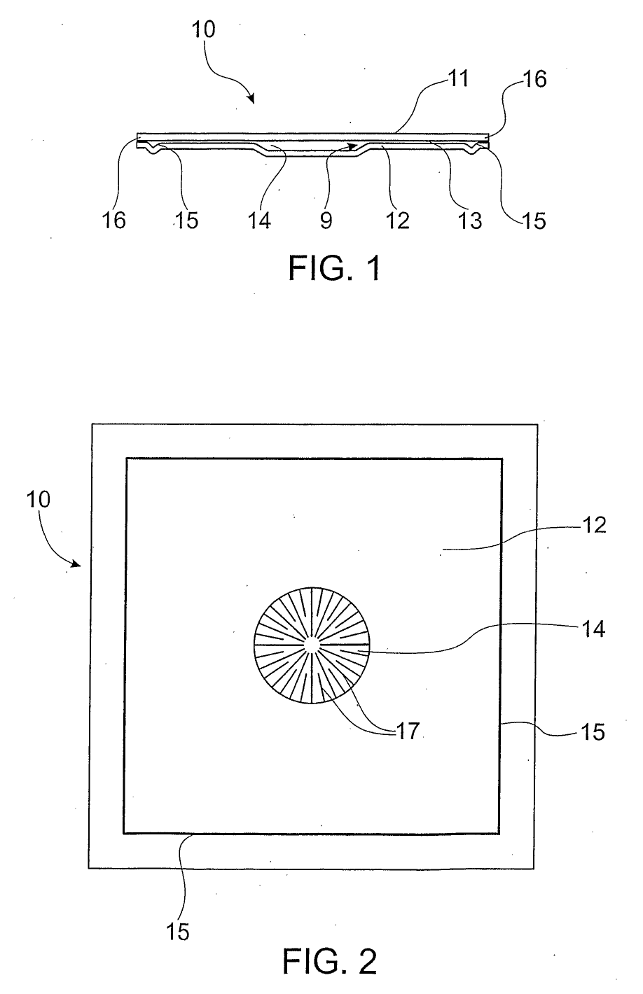

FIGS. 1 to 4 show a first embodiment of a dispenser of the present invention.

FIG. 1 shows a cross sectional view of dispenser 10. Dispenser 10, in the form of a flat container, comprises top wall 11, bottom wall 12 and internal space 9. Top wall 11 and bottom wall 12 are attached or fused at a perimeter of the dispenser at point 16 providing an internal space 9, internal reservoir 14 and a narrow gap 13 between walls 11 and 12. The internal surface of bottom wall 12 may have a peripheral well 15 located in close proximity to the perimeter of bottom wall 12. Internal space 9 includes internal reservoir 14, gap 13 and peripheral well 15.

Preferably, narrow gap 13 falls within the range 5 to 1000 microns.

More preferably, narrow gap 13 falls within the range 40 to 200 microns.

FIG. 2 shows a plan view of the internal surface of bottom wall 12 and illustrates peripheral well 15 and internal reservoir 14 with a radially ribbed or corrugated internal surface 17. Ribbed or corrugated internal surface 17 facilitates movement or spread of the volatile material located within the reservoir throughout the internal space of the dispenser.

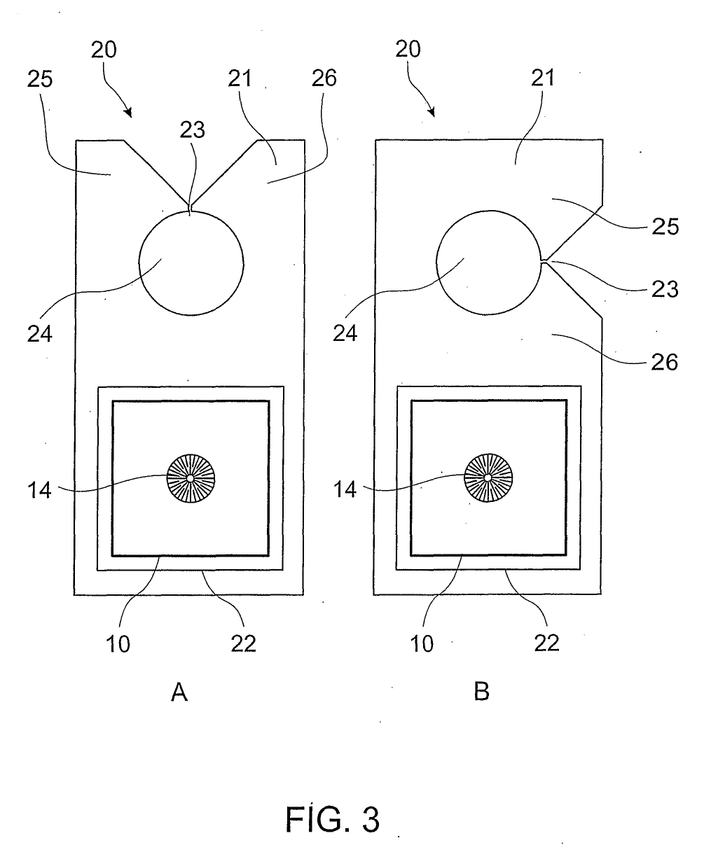

FIG. 3 shows two embodiments of an attachment means or holder for dispenser 10 in the form of clip 20. Clip 20 comprises a planar, sheet-like or plate-like body 21, dispenser attachment or support slot or aperture 22 and slot 23 providing access to attachment aperture 24. Slot 23 is defined by opposed resilient parts or arms 25 and 26 of clip 20. Dispenser 10 has a shape complementary to aperture 22, and dispenser 10 is attached to aperture 22 by snap or interference fit. Dispenser 10 may also be attached to aperture 22 by other attachment means such as adhesive or spot welding. FIGS. 3A and 3B illustrate different orientations of slot 23 and attachment aperture 24 which enables attachment of clip 10 to a limb of a tree, for example.

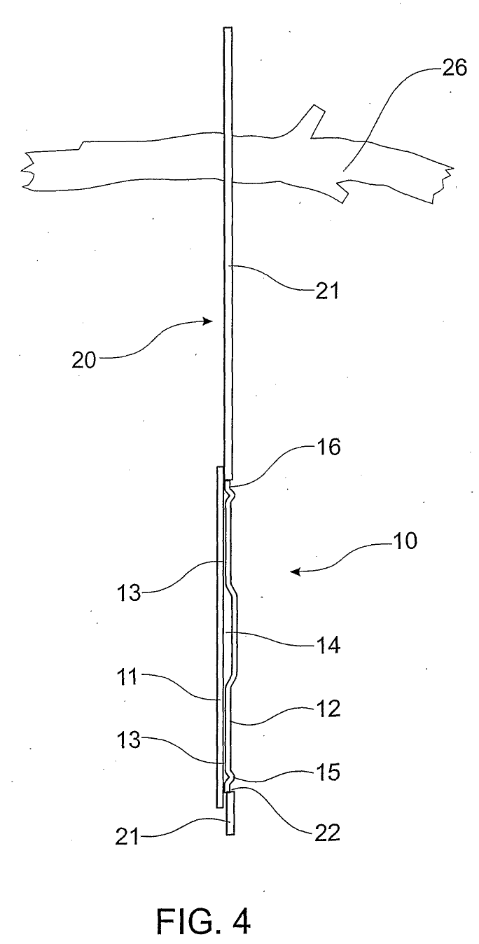

FIG. 4 shows a side view of a clip 20 holding or housing a dispenser 10. Clip 20 is attached to a branch or twig of a tree or vine 26 through attachment aperture 24 (not shown). Dispenser 10 is attached to attachment slot or aperture 22 by snap or interference fit.

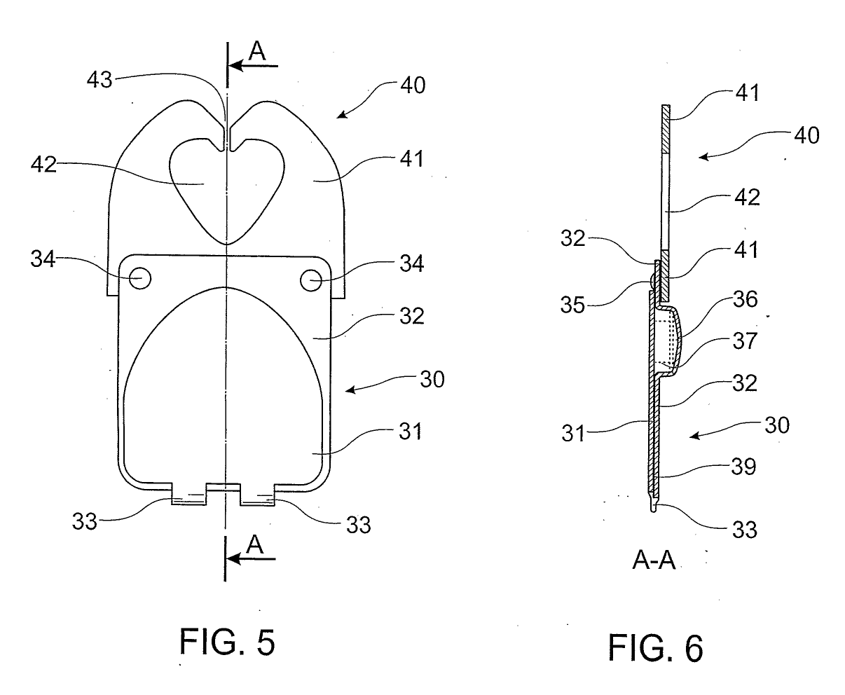

FIGS. 5 to 13 show a second embodiment of a dispenser of the invention.

FIG. 5 shows a plan view of dispenser 30 attached to clip 40. Dispenser 30 comprises top wall 31, bottom wall 32 and attachment apertures or mating slots 34 located in bottom wall 32. Top wall 31 and bottom wall 32 are connected by hinges 33.

Clip 40 comprises a planar, sheet-like or plate-like body 41, attachment slot or aperture 42 and slot 43 providing access to attachment aperture 24. Dispenser 30 is attached to clip 40 by fasteners 35 (see FIG. 6). Fasteners 35 may be integral with, and project from, clip body 41, and extend through attachment apertures or mating slots 34 by interference fit. It will be appreciated by a person skilled in the art that dispenser 30 can be fastened to clip 40 by suitable fastening means, such as a pin, adhesive or a staple.

FIG. 6 is a cross sectional view of dispenser 30 and clip 40 taken through A-A in FIG. 5. Bottom wall 32 of dispenser 30 has a reservoir 36. Reservoir 36 is located off-centre as shown. Dispenser 30 has an internal space 37 and a narrow gap 39 between walls 31 and 32. Bottom wall 32 of dispenser 30 is attached to body 41 of clip 40 by pins 35.

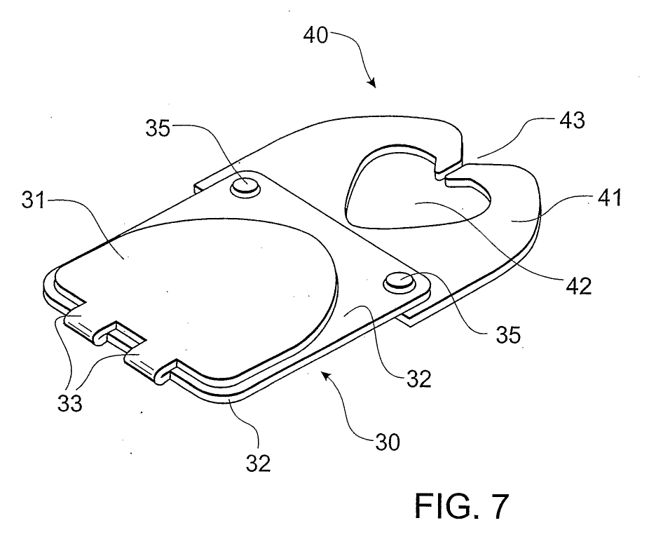

FIG. 7 is a perspective view of dispenser 30 attached to clip 40 by fasteners or pins 35.

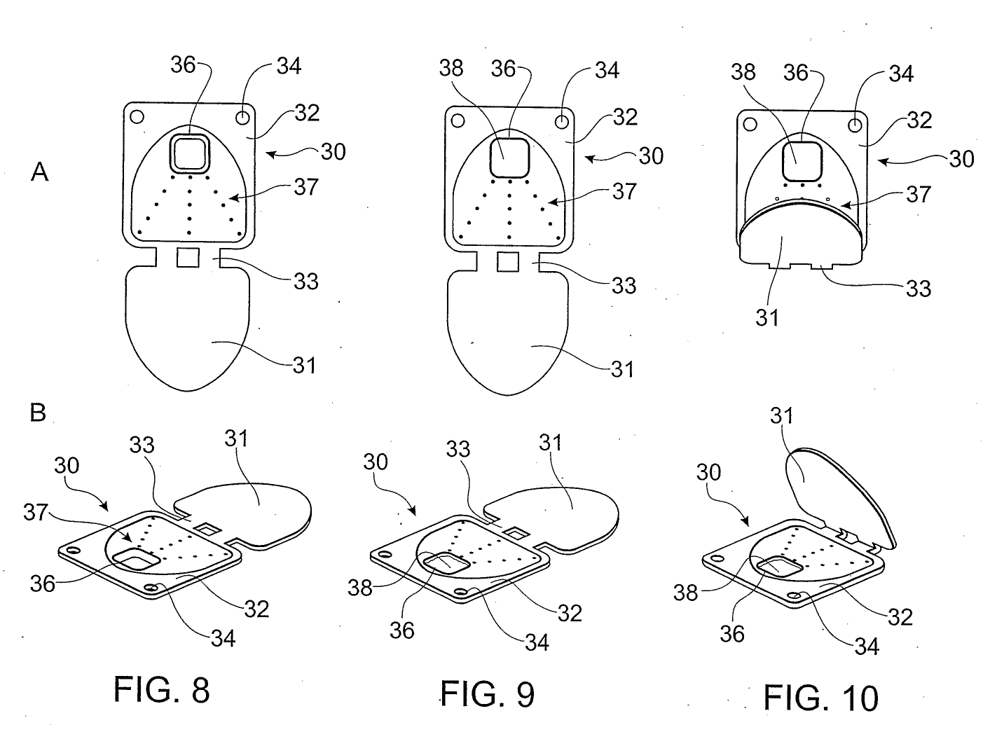

FIGS. 8 to 13 show plan (A) and perspective (B) views of dispenser 30 illustrating the steps of filling the dispenser with volatile material and attaching dispenser 30 to clip 40.

FIG. 8 shows dispenser 30 in an open configuration. Reservoir 36 of dispenser 30 is empty and has internal space 37.

FIG. 9 shows dispenser 30 in an open configuration. Reservoir 36 of dispenser 30 has been filled with volatile material 38.

FIG. 10 shows dispenser 30 being closed. When dispenser 30 is closed top wall 31 is folded along hinges 33 to abut bottom wall 32 and cover or shield reservoir 36.

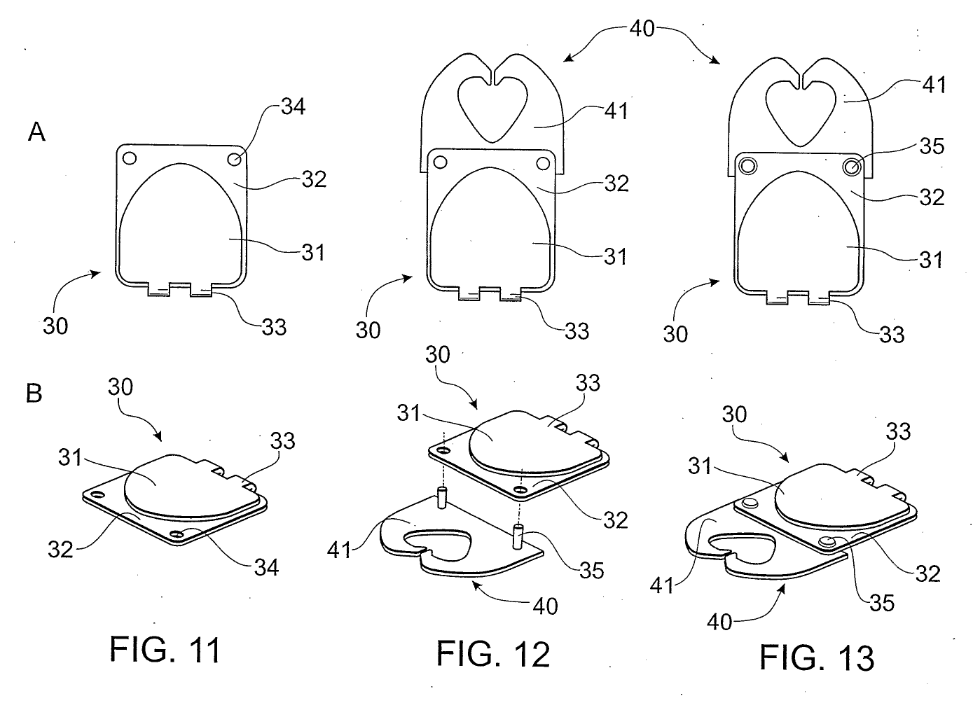

FIG. 11 shows dispenser 30 in a closed configuration wherein top wall 31 covers reservoir 36. Top wall 31 can be secured or sealed to bottom wall 32 by heat or preferably ultrasonic sealing.

FIG. 12 shows the attachment of dispenser 30 to clip 40. When dispenser 30 is attached to clip 40, dispenser 30 is orientated as shown in FIG. 12 so apertures or mating slots 34 align with fasteners or projections 35 of clip 40. Projections 35 are inserted into apertures or mating slots 34. Apertures 34 engage fastening means or projections 35 by interference fit.

FIG. 13 shows dispenser 30 secured to clip 40 and ready for use.

Dispensers 10 and 30 control release of a volatile material, such as a semiochemical or fragrance, which is retained within the dispenser in internal space 9 or 37 which includes reservoir 14 or 36, respectively. Internal space 9 or 37 preferably has a capacity of 50-5000 μl. Walls 11, 12, 31 and 32 are comprised of a material that is permeable to a volatile material, such as a polymer. Preferably, the polymer is selected from the group consisting of ethylene vinyl acetate, polyethylene, polypropylene, and copolymers of polyethylene and polypropylene consisting of ethylene vinyl acetate, polyisoprene, neoprene rubber, natural rubber, polybutyl rubber, silicone and the above polymers admixed with inert fillers such as mineral clays and carbon black.

Preferably, the polymer from which the dispenser is made contains pigments selected from the group consisting of carbon black, titanium dioxide, ferric oxide and zinc oxide which serve to protect the contents of the dispenser from degradation by sunlight. Similarly, the polymer may contain UV stabilizers, such as benzophenones and benzotriaziles.

Walls 11, 12, 31 and 32 may have a thickness of 250 to 2000 microns, which provides the volatile material retained within the walls with buffering or protection against temperature fluctuations in the environment. Preferably, the walls have a thickness of 700 to 1000 microns.

The walls also facilitate constant release of the volatile material from the dispenser. Furthermore, the walls provide rigidity to the dispenser which permits easy mounting to an attachment means for attachment or suspension of the dispenser to a tree limb or vine, such as clips 20 and 40.

The internal surfaces of walls 11 and 12 are in close proximity (gap 13 is 5 to 1000 microns). The arrangement facilitates passage of the volatile material across the internal surfaces of the walls of the dispenser. The width of gap 13 may vary throughout the dispenser. For example, the width of gap 13 may be greater about the perimeter of the dispenser compared to the width of gap 13 located about the centre of the dispenser, or the region of the dispenser located close to the internal reservoir.

The volatile material diffuses through walls 11, 12, 31 and 32 and evaporates into the atmosphere surrounding the dispenser through the external surfaces of walls 11, 12, 31 and 32.

The internal surfaces of walls 11, 12, 31 and 32 remain wet with volatile material until the supply of volatile material in the internal space or reservoir is exhausted. This results in constant and sustained release at constant temperature of the volatile material, i.e. zero order release, of the volatile material from the dispenser.

Preferably, the internal wall surfaces comprising or adjacent the reservoirs 14 and 36 are moulded to give a roughened or radially ribbed surface 17 (see FIG. 2) to facilitate volatile material movement across, and wetting of, the internal surface of the reservoir and walls 11, 12, 31 and 32 by capillary action. This facilitates transference of the volatile material from the reservoir to the internal surfaces of the walls which results in more constant and efficient release of volatile material from the dispenser. The internal surfaces of the reservoir remain constantly wet with volatile material until the supply of volatile material is exhausted enabling constant release (or zero order release) of volatile material from the dispenser.

Peripheral well 15, located around the perimeter of the internal surfaces of layers 11 and 12 (FIG. 1), helps prevent the spread of the volatile material to the extreme edges of the walls 16. Walls 11 and 12 are sealed together at the perimeter and the oily nature of some volatile materials, such as semiochemicals, may interfere with the sealing of the walls.

The semiochemicals may be any biologically active volatile compound. Examples of kairomones are provided in U.S. Pat. No. 6,074,634, in the name of Lopez et al., incorporated herein by reference. The mixture of kairomones described in U.S. Pat. No. 6,074,634 or similar mixtures of plant semiochemicals or volatiles are effective in attracting Helicoverpa and related noctuid moth pests.

Examples of noctuid attractants are provided in International Patent Application No. PCT/AU02/01765, in the name of Bioglobal Ltd, also incorporated herein by reference. Examples include phenylacetaldehyde, methyl 2-methoxybenzoate, limonene, methyl salicylate, anisyl alcohol, beta caryophyllene, anethole and linalool.

Examples of allomones include plant defensive chemicals such as tea tree oil, limonene, thymol and carvacrol.

The semiochemical may be admixed with one or more of the following additives: anti-oxidants, diluents and ultraviolet stabilizers.

Anti-oxidants may be any substance that improves the shelf life of the semiochemical and prevents unwanted degradation and/or oxygenation of the semiochemical. Preferably, the anti-oxidants are selected from the group consisting of butylated hydroxytoluene, butylated hydroxyanisole, vitamin E, vitamin E acetate, alpha tocopherol, alpha tocopherol acetate, propyl gallate, ascorbyl palmitate, hydroquinone monoethyl ether and tertiary butyl hydroquinone. These anti-oxidants may be used as stabilizers for any volatile chemical which is subject to oxidation including fragrances, plant hormones, aromatic aldehydes used as antifungal agents, and allomone compounds.

Ultraviolet stabilisers may be selected from the group consisting of benzophenones, benzotriazoles and hindered amine stabilizers known in the art.

Ultraviolet stabilisers may also be incorporated in the polymer forming the walls of the dispenser. Suitable ultraviolet stabilizers for this means may be selected from the group consisting of pigments, such as titanium dioxide, carbon black, zinc oxide or ferric oxide, and benzophenones, benzotriazoles and hindered amine stabilizers.

Diluents may be selected from the group consisting of alkanes (carbon chain length 6-12), petroleum ethers, aliphatic alcohols (carbon chain length 2-12), terpenes, such as limonene and terpinene, pinene, and oxygenated terpenes, such as 1,4 cineole and terpineol.

The release rate of the volatile material from the dispenser is determined by the following factors (as demonstrated in the Examples):
(i) the thickness of the walls of the dispenser;
(ii) the surface area of the walls of the dispenser;
(iii) the selected polymer or polymers from which the dispenser is made; and
(iv) the molecular weight, vapour pressure and volatility of the volatile material within the dispenser.

Therefore, the release rate of volatile material from the dispenser can be changed or manipulated by a user depending on the application of the dispenser and the conditions under which the dispenser is to be used.

The dispenser of the first embodiment is preferably manufactured in two parts (top and bottom walls 11 and 12) by injection moulding. However, the dispenser may also be manufactured using extrusion techniques (second embodiment). Reservoirs 14 and 36 may be formed using a hot or ultrasonic press or a vacuum forming step after the extrusion step.

Suitably, bottom wall 12 containing reservoir 14 and well 15 may be manufactured by injection moulding and top wall 11 may be manufactured by extrusion.

After manufacture of the dispenser, reservoir 14 is filled with volatile material, preferably by means of an automated metering pump dispensing the semiochemical into the reservoir.

Once reservoir 14 is filled, walls 11 and 12 are sealed around the perimeter 16 using heat or preferably ultrasonic sealing.

The dispenser of the second embodiment of the invention can be made using a single cavity injection moulding die designed for the purpose.

The controlled release devices were individually filled using a hand held automatic pipette. The cover was sealed to the reservoir using a pneumatically driven Branson 800 ultrasonic sealer with a sealing horn and a nest designed specifically for the purpose. Once the reservoir of the dispenser is filled with volatile material, the dispenser is sealed using an ultrasonic sealer, and a horn and nest.

Therefore, the dispensers of the invention are cheap to manufacture.

The amount of volatile material or active ingredient inserted or loaded into a dispenser depends on the following:
(i) the period of time the dispenser is required to be used, for example one, three or five months; and
(ii) the molecular weight, vapour pressure and volatility of the volatile material.

For example, more volatile material is loaded into a dispenser that required to release volatile material for a period of five months than a dispenser required to release volatile material for a period of three months.

If a dispenser is only required for a period of one to two months the internal reservoir may only be half loaded with volatile material prior to use.

If a dispenser is required for a period of four to five months the internal reservoir may only be fully loaded with volatile material prior to use.

It will be appreciated by a person skilled in the art that the internal reservoir can be altered, for example the size of the reservoir can be increased or decreased to contain more or less volatile material, depending on the application of the dispenser and the length of time a user requires the dispenser to release volatile material.

The dispenser can be filled with volatile material that is toxic to insects or has antibacterial or antifungal properties. Examples of volatile material that are toxic to insects include essential oils, such as tea tree oil, orange peel oil, cedar wood oil, lemon grass oil, lemon scented gum oil and ginger grass oil.

Examples of other suitable volatile materials which are toxic to insects include limonene, linalool, terpinen-4-ol and methyl salicylate.

Examples of volatile compounds which have an antibacterial and antifungal effects include natural compounds, such as benzaldehyde, anisaldehyde and cinnamaldehyde, thymol, carvacrol.

The dispenser can also be filled with a volatile material that is a plant growth regulator. Examples of compounds which are plant growth regulators include methyl jasmonate, cis-jasmone and methyl salicylate.

Furthermore, the dispenser can be filled with a volatile material that is a perfume or fragrance. Examples of perfumes or fragrances include boronia flower oil, coriander seed oil, tuberose flower oil and oil of jasmine.

Further examples of perfumes which can be released from the dispensers of the invention include those listed in The European Commission's List of Fragrance Chemicals (http://www.fpinva.org/Composition/EU.htm), which is incorporated herein by reference.

A dispenser containing perfume or fragrance can be worn on the body of a person or attached to the clothing of a person. For this purpose there are many means of attachment of the dispenser to the body or clothing of a person. For example, the dispenser can be worn as a pendant or brooch. The dispenser can be pinned, attached by adhesive, or sewn onto a piece of clothing.

The dispenser may also be used to release fragrance or air fresheners in vehicles, rooms, cupboards and containers. Depending on the application the dispensers may be affixed to a clip, hook, string or twist tie. Alternatively, the dispenser may be adhered to a support structure using glue, a pin or a nail.

In agricultural use, the dispenser may be inserted into or secured to an attachment means or holder, such as a hook or clip, which allows attachment of the dispenser to the limbs of fruit trees, vines, crops and other supports, such as stakes, wires, poles, string or posts.

Preferably, clips 20 and 40 are planar or flat and may have any suitable shape.

Preferably, clips 20 and 40 are made of a tough and relatively rigid polymer such as, but not limited to, polypropylene, polyethylene, high density polyethylene, polyethylene and polypropylene copolymer, and polyethylene terephthalate. Suitably, the polymer contains at least one fugitive dye or pigment which changes in colour (for example the colour fades) on prolonged exposure to sunlight. The change in colour of clips 20 and 40 allows users to distinguish between dispensers applied to a tree recently from those applied a long time ago, for example, the previous season. A plurality of dyes or pigments may be incorporated into the polymer, for example, a dye that changes in colour and another which does not change colour. The use of two dyes or pigments may enhance the visibility of the colour change.

Examples of suitable dyes and pigments which may change colour on prolonged exposure to light include but are not limited to the following:

Fluorescent Dyes

Solvent Yellow 43, 98, 145

Orange 63

Red 149, 196, 197

Green 5

Vat Red 41

Polymer-Soluble Dyes

Solvent Yellow 14, 16, 33, 93, 114, 141, 145, 163

Solvent Orange 60, 86, 105

Solvent Red 3, 23, 24, 27, 49, 52, 111, 135, 146, 179, 207

Solvent Violet 13, 14, 31

Solvent Blue 12, 35, 36, 63, 78, 97, 104

Solvent Green 3, 28

Disperse Violet 26, 28

Pigment Violet 23

Pigment Blue 15:1, 15:3

Pigment Green 7

While it is preferable that the dye or pigment is incorporated into the polymer at the melt stage prior to forming the clip, it is conceivable that the dye or pigment may be added as a film or coating to the once the clip is formed.

### EXAMPLES

### Example 1

The dispenser of the current invention is useful for controlling insect pests of agriculture and horticulture, for example, the Oriental fruit moth Grapholita molesta, in peaches and stone fruit. 250 milligrams of the sex pheromone (a mixture of Z,8 Dodecen-1-yl acetate, E,8 Dodecen-1-yl acetate, Z,8 Dodecen-1-yl alcohol in a 93:6:1 ratio by weight) may be inserted into each dispenser.

500 dispensers per hectare are applied to the field or orchard before commencement of moth flight in spring.

### Example 2

Control of Codling moth, Cydia pomonella in apples and pears

100 milligrams of the sex pheromone E,E 8,10 Dodecadien-1-yl alcohol is inserted into each dispenser. 1000 dispensers per hectare are applied to the field or orchard before commencement of moth flight in spring.

### Example 3

### Control of aphids, including the Rose aphid, Macrosiphuin rosae

100 milligrams of the sex pheromone E,E 8,10 Dodecadien-1-yl alcohol is inserted into each dispenser. 1000 dispensers per hectare are applied to the field or orchard before commencement of moth flight in spring

E, beta-farnesene, the alarm pheromone of many aphid species together with the plant kairomones methyl salicylate, methyl jasmonate and Z,3 Hexen-1-yl acetate may be inserted into dispensers.

Tea tree oil inserted into dispensers can be used for the control of ant pests such as the Red Imported Fire ant, Solenopsis invicta.

### Example 4

### Release Rate Characteristics of the Dispensers

The release rate of the volatile chemical housed within the dispenser is an objective measure of the effectiveness of the dispenser. A dispenser having a zero order release rate, having constant release at a constant temperature until the dispenser is exhausted is generally regarded as the most efficient system. Dispensers with perfect zero order release characteristics are not wasteful of active ingredient at the commencement of release nor at the end of its life.

Studies were carried out using a dispenser as described above made using an injection moulding die designed for the purpose (FIGS. 8 to 13). The wells or reservoirs of the dispensers were filled with volatile chemicals of different chemical structures. The dispensers were sealed using an ultrasonic sealer and a horn and nest.

Experiments were carried out to determine the release rates of several volatile insect attractants of different chemical structures.

### Experiment 1

The following experiment measured release of codling moth pheromone from dispensers having walls of varying thickness.

The following volatile chemicals were used in the experiment:

| | | |
|---|---|---|
| E,E 8,10 Dodecadien-1-ol | 59.0% | w/w |
| Dodecanol | 32.0% | w/w |
| Tetradecanol | 7.5% | w/w |
| Tinuvin 327 | 0.5% | w/w |
| BHT | 1.0% | w/w |

The dispensers were made from ethylene vinyl acetate polymer (Elvax 660). Dispensers with walls of three different thicknesses were used, 0.59 mm, 0.62 mm and 0.70 mm. Twenty dispensers were mounted in an incubator with a temperature of 24° C. to 27° C.

Measurements were made to an accuracy of 0.1 mg.

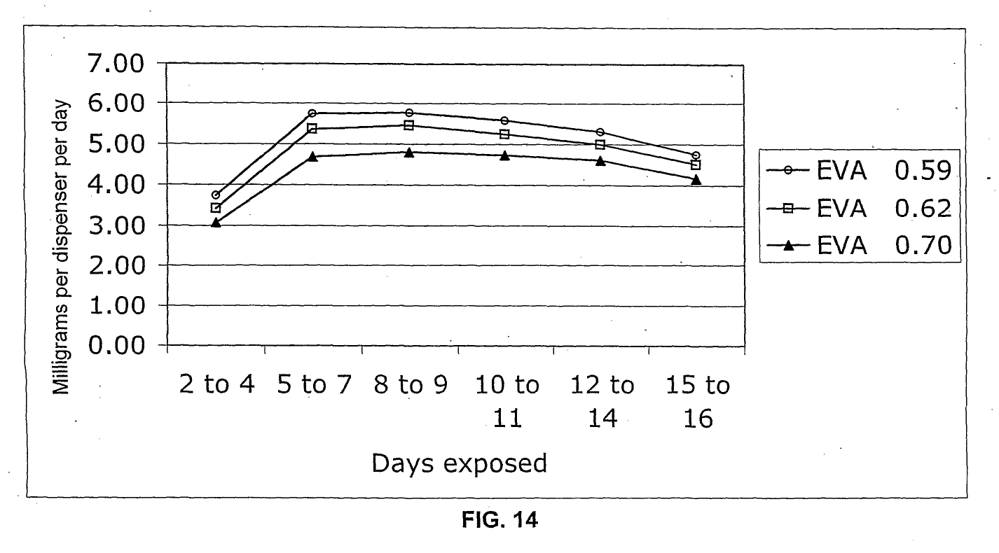

The results of the release rates of the dispensers (milligrams/dispenser/day) are shown in Table 1 and FIG. 14. In Tables 1 to 8 stdev refers to standard deviation.

After an initial period of 3 to 4 days during which the semiochemical within the dispenser and in the dispenser walls was reaching equilibrium, the release rate of the dispensers settled to a steady state which approximated zero order release. Increasing the wall thickness of the dispenser resulted in a decrease in release rate.

### Experiment 2

The following experiment measured release of codling moth pheromone from dispensers having walls of varying thickness.

The following volatile chemicals were used in the experiment:

| | | |
|---|---|---|
| E,E 8,10 Dodecadien-1-ol | 59.0% | w/w |
| Dodecanol | 32.0% | w/w |
| Tetradecanol | 7.5% | w/w |
| Tinuvin 327 | 0.5% | w/w |
| BHT | 1.0% | w/w |

The dispensers were made from ethylene vinyl acetate polymer (Elvax 660). Dispensers with walls of two different thicknesses were used; 0.9 mm and 1.0 mm.

Twenty dispensers were mounted in an incubator with a temperature of 26° C. to 29° C.

Measurements were made to an accuracy of 0.1 mg.

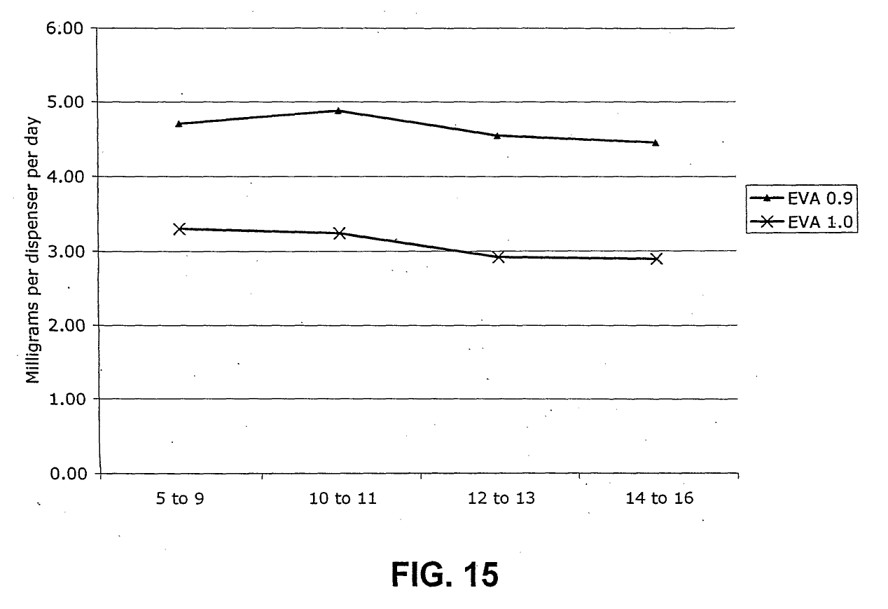

The dispenser release rates (milligrams/dispenser/day) are shown in Table 2 and FIG. 15.

The release rate of the dispensers settled to a steady state after three to four days which approximated zero order release. The results demonstrated that increasing the wall thickness of the dispenser resulted in a decrease in release rate of the volatile chemicals.

The release rate of the volatile chemicals may be increased or decreased by manufacturing the dispenser from a combination of polymers that are permeable and impermeable to the volatile chemical in question.

### Experiment 3

Release of codling moth pheromone with dispensers comprised of ethylene vinyl acetate and low density polyethylene Series 1.

The following volatile chemicals were used in the experiment:

| | | |
|---|---|---|
| E,E 8,10 Dodecadien-1-ol | 59.0% | w/w |
| Dodecanol | 32.0% | w/w |
| Tetradecanol | 7.5% | w/w |
| Tinuvin 327 | 0.5% | w/w |
| BHT | 1.0% | w/w |

The dispensers were made from EVA polymers (Elvax 660) and low density polyethylene (LDPE).

The wall thickness of the dispensers was 1.0 mm. Twenty dispensers were mounted in an incubator with a temperature of 26° C. to 29° C.

Measurements were made to an accuracy of 0.1 mg.

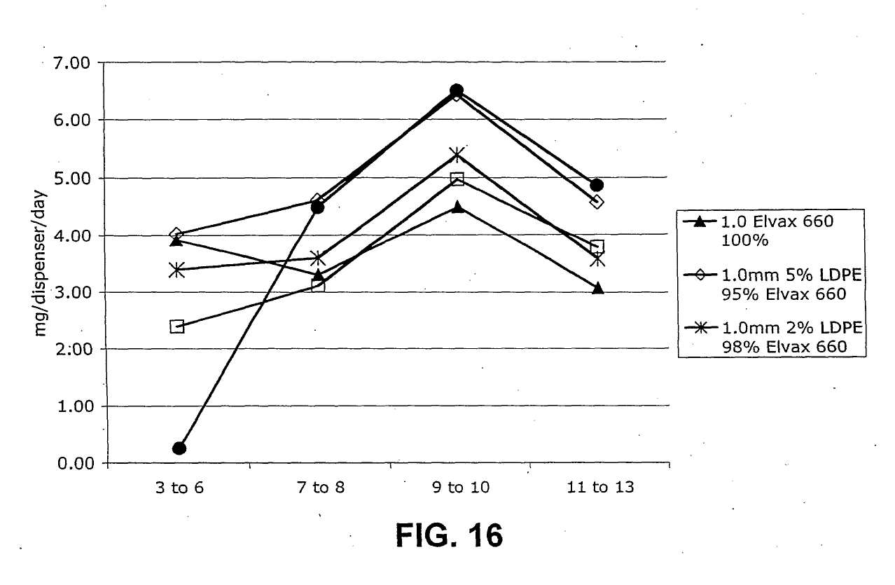

The dispenser release rates (milligrams/dispenser/day) are shown in Table 3. A graph of the data is shown in FIG. 16.

Some of the dispensers had not reached equilibrium with the environment by the time of the first measurement. Some difficulties were experienced in maintaining constant temperature in the incubator room. Addition of LDPE to Elvax 660 in the ratio 2% to 98% increased the release rate of codling moth pheromone when compared with the release rate of pheromone using a dispenser comprising 100% Elvax 660. Addition of LDPE to Elvax 660 in the ratio 5% to 95% and 10% to 90% increased the release rate of pheromone when compared with the release rate of pheromone using a dispenser comprising LDPE to Elvax 660 in the ratio 2% to 98%.

Addition of LDPE to Elvax 660 in the ratio 20% to 80% increased the release rate of codling moth pheromone when compared with the release rate of pheromone using a dispenser comprising 100% Elvax 660. Given that LDPE does not permit the passage of codling moth pheromone at an efficient rate, these results are interesting. At the above ratios, the polymers combined and moulded without difficulty.

Blending of the Elvax 660 and LDPE in the range of ratios of 98% to 2% to 80% to 20% is a method of increasing the release rate of volatile chemicals housed within the dispenser.

### Experiment 4

Release of codling moth pheromone with dispensers comprised of EVA and low density polyethylene (Series 2).

The following volatile chemicals were used in the experiment:

| | | |
|---|---|---|
| E,E 8,10 Dodecadien-1-ol | 59.0% | w/w |
| Dodecanol | 32.0% | w/w |
| Tetradecanol | 7.5% | w/w |
| Tinuvin 327 | 0.5% | w/w |
| BHT | 1.0% | w/w |

The dispensers were made from EVA polymers (Elvax 660) and low density polyethylene (LDPE).

The wall thickness of the dispensers was 1.0 mm. Twenty dispensers were mounted in an incubator with a temperature of 26° C. to 29° C.

Measurements were made to an accuracy of 0.1 mg.

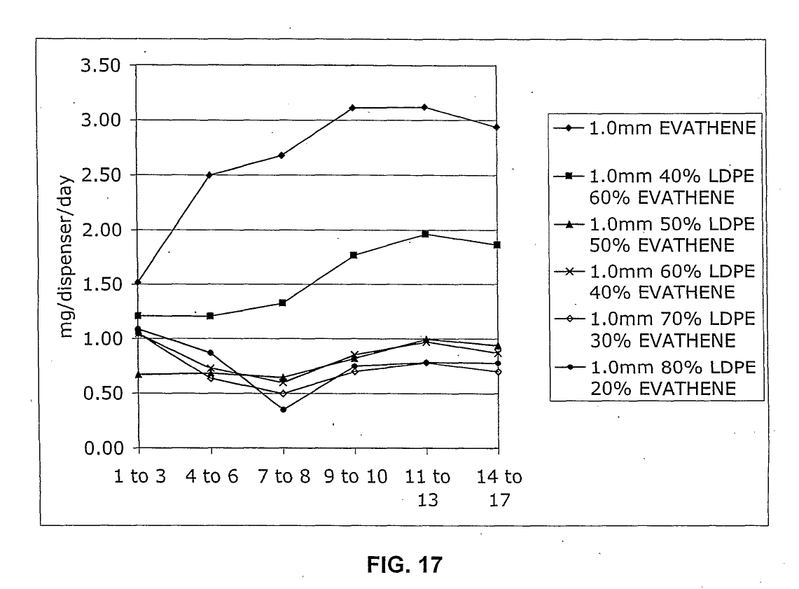

The dispenser release rates (milligrams/dispenser/day) are shown in Table 4. A graph of the data is shown in FIG. 17.

At the time of the first measurement most of the dispensers had not reached equilibrium. Some difficulties were experienced in maintaining constant temperature in the incubator room. Whereas the addition of LDPE to EVA (EVATHENE) in the dispenser in the ratios 2% to 98%, 5% to 95% and 10% to 90% increased the release rate of codling moth pheromone when compared with 100% EVA, the addition of LDPE to EVA in the ratios 40% to 60%, 50% to 50%, 60% to 40%, 70% to 30% and 80% to 20% decreased the release rate of the pheromone from the dispenser compared to the release rate achieved with 100% Elvax 660. The release rates using LPDE to EVA ratios of 50% to 50%, 60% to 40%, 70% to 30% and 80% to 20% did not differ markedly.

In terms of ease of moulding, the ratios of LDPE to EVA of 40% to 60%, 50% to 50% and 60% to 40% were not ideal for injection moulding purposes.

### Experiment 5

Release of codling moth pheromone with dispensers comprised of EVA of different polymer specifications.

The following volatile chemicals were used in the experiment:

| | | |
|---|---|---|
| E,E 8,10 Dodecadien-1-ol | 59.0% | w/w |
| Dodecanol | 32.0% | w/w |
| Tetradecanol | 7.5% | w/w |
| Tinuvin 327 | 0.5% | w/w |
| BHT | 1.0% | w/w |

The dispensers were made from EVA polymers (Elvax 660 and Elvax 750, Dupont).

The wall thickness of the dispensers was 1.0 mm. Twenty dispensers were mounted in an incubator with a temperature of 26° C. to 29° C.

The gravimetric measurement accuracy 0.1 mg

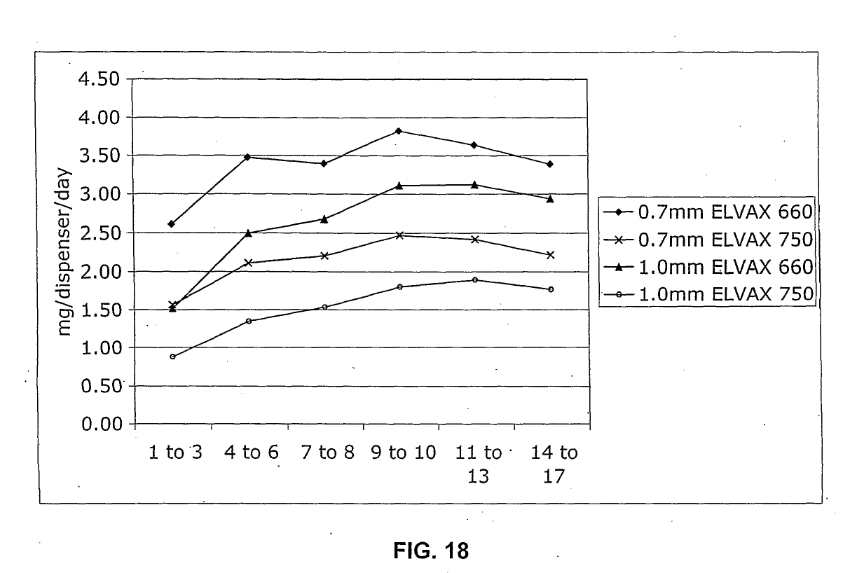

The dispenser release rates (milligrams/dispenser/day) are shown in Table 5. A graph of the data is shown in FIG. 18.

After reaching equilibrium, all the dispensers released pheromone at a steady rate given the variability in temperature in the incubator room. From the data in Table 5, it is clear that that different grades of EVA as well as different wall thicknesses has a marked effect on the release-rate of pheromone from the dispenser. Elvax 750 EVA has a slower release rate than Elvax 660 EVA.

It was easier to work with pure polymers rather than with blends of EVA and LDPE, particularly when the ratios of LDPE to EVA required giving the desired release rate approached a 50 to 50 ratio. The target release rate was 1.27 mg of pheromone per dispenser per day.

A slower release rate of pheromone is required than can be obtained with pure EVA polymers, if the pheromone mixtures described above are to be used. Lowering the release rate can be achieved by reducing the surface area of the dispenser.

However, this presents the risk that unstable pheromone may accumulate on the surface of the dispenser and degrade in sunlight rather than being released. It is better to maintain a larger than minimal surface area from which the pheromone can evaporate and decrease the release rate in some other way.

Another method for reducing the release rate of the pheromone is to introduce or increase the level of diluent in the pheromone mixture which releases from the dispenser at the same rate as the pheromone and which has no adverse biological effects.

In the case of codling moth pheromone, dodecanol, the saturated form of the active codling moth pheromone (E,E 8,10 dodecadien-1-ol) meets these requirements. Dodecanol is found in the pheromone gland of the female codling moth. It has been shown to have no inherent biological activity but it is about the same molecular weight as E,E 8,10 dodecadien-1-ol (active pheromone) and has a chemical structure which is very close to E,E 8,10 dodecadien-1-ol. Dodecanol has an additional advantage of lowering the melting point of the pheromone formulation and thereby increasing the release rate of the pheromone formulation in cool conditions which are encountered in the early part of the apple growing season.

By increasing the concentration of Dodecanol in the pheromone formulation, the effective release rate of the active component can be reduced to an optimum level. If Elvax 750 polymer is used and the dispenser filled with a mixture of E,E 8,10 dodecadien-1-ol and dodecanol at the ratio of 40 to 60% w/w, an optimum release rate can be obtained.

The above results suggest that the dispenser has a larger reservoir than might be required. However, a larger reservoir allows the user to design dispensers which may contain the pheromone at a higher concentration than contained in other dispensers. Use of a larger reservoir in a dispenser may allow a smaller number of dispensers to be used per area.

### Experiment 6

Release of tomato pinworm pheromone from dispensers manufactured from polymers of different wall thicknesses

The following volatile chemicals were used in the experiment

| | | |
|---|---|---|
| E,4 Tridecenyl acetate | 99.0% | w/w |
| BHT | 1.0% | w/w |

The dispensers were made from EVA polymer (Elvax 660) and LPDE.

The wall thickness of the dispensers was 1.0 nm. Ten dispensers were mounted in an incubator with a temperature of 26° C. to 29° C.

Measurements were made to an accuracy of 0.1 mg.

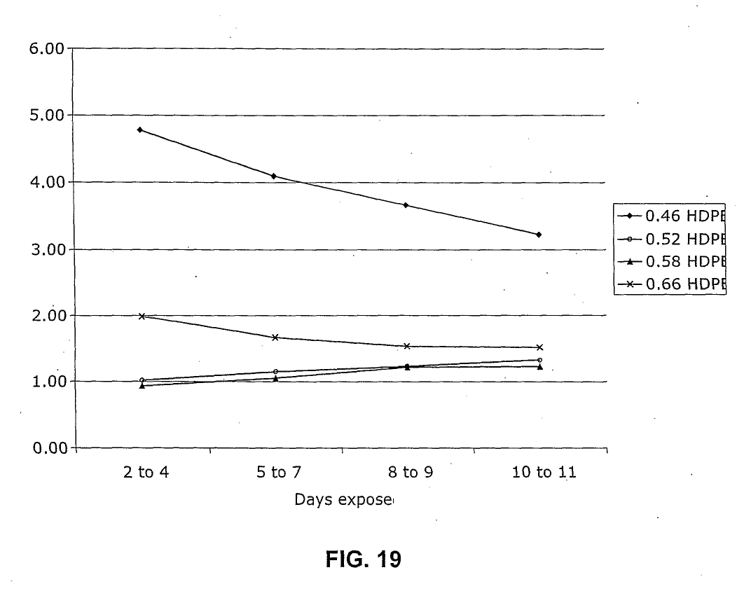

The mean dispenser release rates (milligrams/dispenser/day) are shown in Table 6. A graph of the data is shown in FIG. 19.

The tomato pinworm pheromone was released at a steady rate approaching zero order from the dispensers. LDPE was a suitable polymer for release of this pheromone. As above the release rates were determined by polymer wall thickness.

### Experiment 7

Release of oriental fruit moth pheromone with dispensers comprised of blends of HDPE and LDPE with walls of varying wall thicknesses.

The following volatile chemicals were used in the experiment:

| | | |
|---|---|---|
| Z,8 Dodecen-1-yl acetate | 90.5% | w/w |
| E,8 Dodecen-1-yl acetate | 6.0% | w/w |
| Z,8 Dodecen-1-ol | 2.0% | w/w |
| Tinuvin 327 | 0.5% | w/w |
| BHT | 1.0% | w/w |

The dispensers were made from Polymer mixtures of LDPE 25% to HDPE 75% and LDPE 50% to HDPE 50%.

The wall thickness of the dispensers were 0.70, 0.80, and 0.90 mm. Twenty dispensers were mounted in an incubator with a temperature of 26° C. to 29° C.

Measurements were made to an accuracy of 0.1 mg.

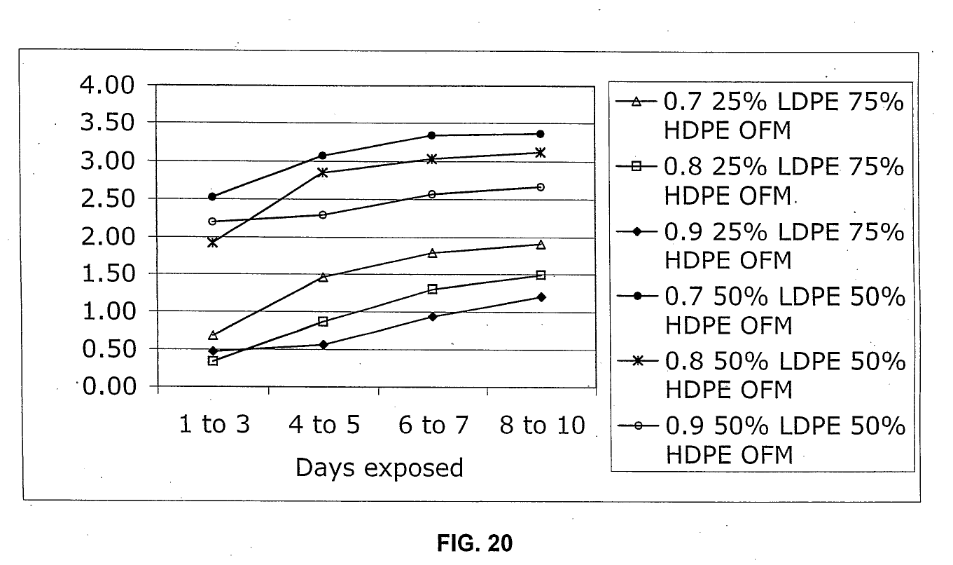

The mean dispenser release rates (milligrams/dispenser/day) are shown in Table 7. A graph of the data is shown in FIG. 20.

The dispensers approached a steady release rate which was determined by the polymer blend wall thickness. The target release rate for the dispensers under the conditions of the experiment was 2.15 mg per dispenser per day. Dispensers manufactured of 50% LDPE to 50% HDPE polymer with a wall thickness of 0.9 mm, and 25% LDPE to 75% HDPE with a wall thickness of 0.7 mm had the best release rates.

### Experiment 8

Release of oriental fruit moth pheromone with dispensers comprised of HDPE and Linear LDPE of different wall thicknesses.

The following volatile chemicals were used in the experiment:

| | | |
|---|---|---|
| Z,8 Dodecen-1-yl acetate | 90.5% | w/w |
| E,8 Dodecen-1-yl acetate | 6.0% | w/w |
| Z,8 Dodecen-1-ol | 2.0% | w/w |
| Tinuvin 327 | 0.5% | w/w |
| BHT | 1.0% | w/w |

The dispensers were made from Polymer mixtures of LDPE 25% to HDPE 75% and LDPE 50% to HDPE 50%.

The wall thickness of the dispensers was 0.70, 0.80, and 0.90 mm. Twenty dispensers were mounted in an incubator with a temperature of 26° C. to 29° C.

Measurements were made to an accuracy of 0.1 mg.

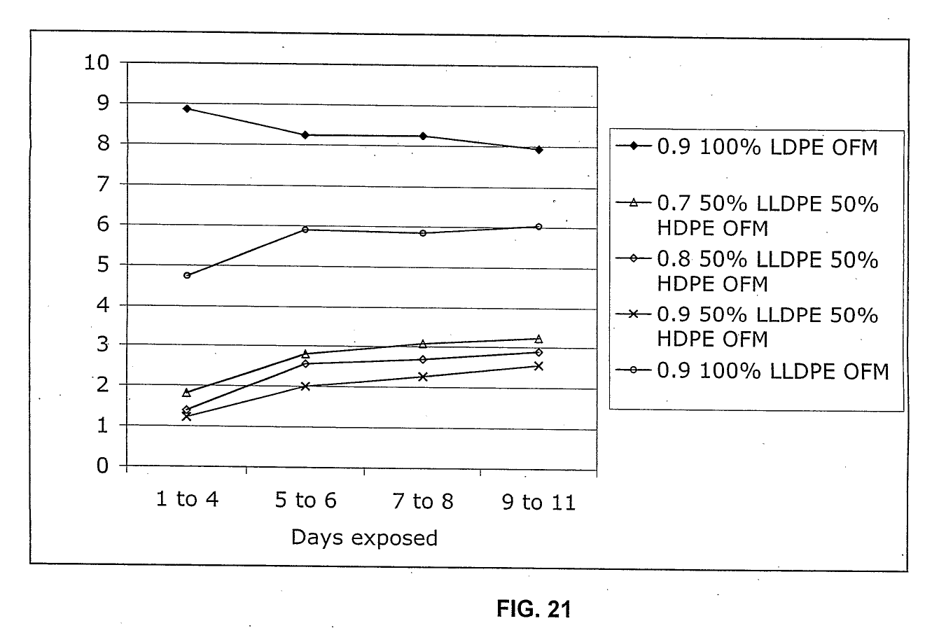

The mean dispenser release rates (milligrams/dispenser/day) are shown in Table 7. A graph of the data is shown in FIG. 21.

The dispensers approached a steady release rate which was determined by the wall thickness of the polymer blend. The target release rate for the dispensers under the conditions of the experiment was 2.15 mg per dispenser per day. The dispensers manufactured of 50% LDPE to 50% HDPE polymer with a wall thickness of 0.9 mm had the best release rate.

The invention as shown in the above preferred embodiments has the following advantages and uses:
1. minimal wastage of semiochemical;
2. lower levels of the active semiochemicals and agents may be used to achieve the same level of pest control as achieved by commercial formulations containing higher levels of semiochemicals;
3. the dispenser provides a constant rate (zero order release) and continuous release of the semiochemical over a long period of time;
4. the dispenser maintains a constant rate of release under a variety of temperatures and conditions;
5. the dispenser provides flexibility of loading of the dispenser with volatile material, i.e. the dispenser can be filled with a specific amount of volatile material depending on the period of time that the user wishes to use the dispenser;
6. the installation or suspension of the dispenser is easy and not time consuming;
7. the dispensers are cheap to manufacture;
8. the volatile materials housed within the dispenser are protected from sunlight and oxidation;
9. the dispenser is easily visible from the ground; and

10. old and new dispensers are easily distinguished.

TABLE 1

| | Days exposed | | | | | | | | | | | |
|---|---|---|---|---|---|---|---|---|---|---|---|---|
| | 2 to 4 | | 5 to 7 | | 8 to 9 | | 10 to 11 | | 12 to 14 | | 15 to 16 | |
| | Mean | Stdev | Mean | Stdev | Mean | Stdev | Mean | Stdev | Mean | Stdev | Mean | Stdev |
| Elvax 660 0.59 | 3.74 | 0.28 | 5.74 | 0.95 | 5.78 | 0.94 | 5.59 | 0.72 | 5.32 | 0.66 | 4.75 | 0.52 |
| Elvax 660 0.62 | 3.43 | 0.24 | 5.37 | 0.84 | 5.47 | 0.94 | 5.26 | 0.81 | 5.00 | 0.69 | 4.51 | 0.59 |
| Elvax 660 0.70 | 3.07 | 0.38 | 4.69 | 0.96 | 4.80 | 0.96 | 4.72 | 0.81 | 4.60 | 0.64 | 4.17 | 0.58 |

TABLE 2

| | Days exposed | | | | | | | |
|---|---|---|---|---|---|---|---|---|
| | 5 to 9 | | 10 to 11 | | 12 to 13 | | 14 to 16 | |
| | Mean | Stdev | Mean | Stdev | Mean | Stdev | Mean | Stdev |
| Elvax 660 0.9 | 4.71 | 0.55 | 4.88 | 0.67 | 4.54 | 0..59 | 4.48 | 0.48 |
| Elvax 660 1.0 | 3.30 | 1.16 | 3.24 | 1.05 | 2.92 | 0.97 | 2.89 | 0.95 |

TABLE 3

| | Days exposed | | | | | | | |
|---|---|---|---|---|---|---|---|---|
| | 3 to 6 | | 7 to 8 | | 9 to 10 | | 11 to 13 | |
| | mean | stdev | mean | stdev | mean | stdev | mean | stdev |
| 1.0 Elvax 660 100% | 3.91 | 0.25 | 3.30 | 0.30 | 4.49 | 0.20 | 3.07 | 0.13 |
| 1.0 mm 5% LDPE 95% Elvax 660 | 4.02 | 0.25 | 4.61 | 0.44 | 6.42 | 0.44 | 4.57 | 0.39 |
| 1.0 mm 2% LDPE 98% Elvax 660 | 3.39 | 0.26 | 3.59 | 0.35 | 5.39 | 0.40 | 3.57 | 0.37 |
| 1.0 mm 10% LDPE 90% Elvax 660 | 0.25 | 0.25 | 4.48 | 0.35 | 6.50 | 0.43 | 4.87 | 0.36 |
| 1.0 mm 20% LDPE 80% Elvax 660 | 2.39 | 0.14 | 3.10 | 0.19 | 4.97 | 0.34 | 3.77 | 0.33 |

TABLE 4

| | Days exposed | | | | | | | | | | | |
|---|---|---|---|---|---|---|---|---|---|---|---|---|
| | 1 to 3 | | 4 to 6 | | 7 to 8 | | 9 to 10 | | 11 to 13 | | 14 to 17 | |
| | mean | stdev | mean | stdev | mean | stdev | mean | stdev | mean | stdev | mean | stdev |
| 1.0 mm ELVAX 660 | 1.51 | 0.18 | 2.50 | 0.33 | 2.68 | 0.36 | 3.11 | 0.35 | 3.12 | 0.34 | 2.94 | 0.32 |
| 1.0 mm 40% LDPE 60% EVATHENE | 1.21 | 0.13 | 1.20 | 0.19 | 1.33 | 0.21 | 1.76 | 0.27 | 1.96 | 0.25 | 1.86 | 0.25 |
| 1.0 mm 50% LDPE 50% EVATHENE | 0.67 | 0.08 | 0.68 | 0.05 | 0.64 | 0.11 | 0.82 | 0.08 | 0.99 | 0.07 | 0.94 | 0.15 |
| 1.0 mm 60% LDPE 40% EVATHENE | 1.04 | 0.18 | 0.73 | 0.08 | 0.60 | 0.09 | 0.86 | 0.17 | 0.97 | 0.12 | 0.88 | 0.10 |
| 1.0 mm 70% LDPE 30% EVATHENE | 1.05 | 0.09 | 0.63 | 0.06 | 0.50 | 0.12 | 0.70 | 0.08 | 0.78 | 0.07 | 0.70 | 0.10 |
| 1.0 mm 80% LDPE 20% EVATHENE | 1.09 | 0.10 | 0.87 | 0.75 | 0.35 | 1.13 | 0.75 | 0.08 | 0.79 | 0.15 | 0.78 | 0.24 |

TABLE 5

| | Days exposed | | | | | | | | | | | |
|---|---|---|---|---|---|---|---|---|---|---|---|---|
| | 1 to 3 | | 4 to 6 | | 7 to 8 | | 9 to 10 | | 11 to 13 | | 14 to 17 | |
| | mean | stdev | mean | stdev | mean | stdev | mean | stdev | mean | stdev | mean | stdev |
| 0.7 mm ELVAX 660 | 2.61 | 0.18 | 3.47 | 0.33 | 3.40 | 0.36 | 3.82 | 0.35 | 3.63 | 0.34 | 3.39 | 0.32 |
| 0.7 mm ELVAX 750 | 1.56 | 0.11 | 2.11 | 0.16 | 2.20 | 0.22 | 2.47 | 0.18 | 2.42 | 0.14 | 2.22 | 0.21 |
| 1.0 mm ELVAX 660 | 1.51 | 0.18 | 2.50 | 0.33 | 2.68 | 0.36 | 3.11 | 0.35 | 3.12 | 0.34 | 2.94 | 0.32 |
| 1.0 mm ELVAX 750 | 0.87 | 0.05 | 1.35 | 0.13 | 1.53 | 0.18 | 1.81 | 0.15 | 1.90 | 0.13 | 1.77 | 0.16 |

TABLE 6

| | Days exposed | | | | | | | |
|---|---|---|---|---|---|---|---|---|
| | 2 to 4 | | 5 to 7 | | 8 to 9 | | 10 to 11 | |
| | mean | stdev | mean | stdev | mean | stdev | mean | stdev |
| 0.46 mm HDPE | 1.41 | 0.37 | 1.51 | 0.37 | 1.49 | 0.24 | 1.48 | 0.22 |
| 0.52 mm HDPE | 0.99 | 0.49 | 1.13 | 0.48 | 1.13 | 0.43 | 1.13 | 0.42 |
| 0.58 mm HDPE | 0.65 | 0.20 | 0.79 | 0.19 | 0.90 | 0.21 | 0.89 | 0.20 |
| 0.66 mm HDPE | 0.44 | 0.20 | 0.59 | 0.20 | 0.68 | 0.23 | 0.71 | 0.21 |

TABLE 7

| | Days exposed | | | | | | | |
|---|---|---|---|---|---|---|---|---|
| | 1 to 3 | | 4 to 5 | | 6 to 7 | | 8 to 10 | |
| | mean | stdev | mean | stdev | mean | stdev | mean | stdev |
| 0.7 25% LDPE 75% HDPE OFM | 0.68 | 0.09 | 1.46 | 0.09 | 1.79 | 0.08 | 1.91 | 0.06 |
| 0.8 25% LDPE 75% HDPE OFM | 0.33 | 0.08 | 0.87 | 0.11 | 1.30 | 0.10 | 1.49 | 0.07 |
| 0.9 25% LDPE 75% HDPE OFM | 0.47 | 0.31 | 0.56 | 0.10 | 0.94 | 0.10 | 1.20 | 0.06 |
| 0.7 50% LDPE 50% HDPE OFM | 2.53 | 0.14 | 3.07 | 0.15 | 3.34 | 0.12 | 3.36 | 0.13 |
| 0.8 50% LDPE 50% HDPE OFM | 1.92 | 0.19 | 2.85 | 0.16 | 3.03 | 0.17 | 3.12 | 0.15 |
| 0.9 50% LDPE 50% HDPE OFM | 2.20 | 1.12 | 2.29 | 0.27 | 2.57 | 0.29 | 2.66 | 0.26 |

TABLE 8

| | Days exposed | | | | | | | |
|---|---|---|---|---|---|---|---|---|
| | 1 to 4 | | 5 to 6 | | 7 to 8 | | 9 to 11 | |
| | mean | stdev | mean | stdev | mean | stdev | mean | stdev |
| 0.9 100% LDPE OFM | 8.86 | 0.96 | 8.24 | 0.60 | 8.25 | 0.51 | 7.94 | 0.41 |
| 0.7 50% LLDPE 50% HDPE OFM | 1.81 | 0.10 | 2.80 | 0.12 | 3.07 | 0.11 | 3.23 | 0.08 |
| 0.8 50% LLDPE 50% HDPE OFM | 1.39 | 0.15 | 2.56 | 0.17 | 2.69 | 0.18 | 2.89 | 0.15 |
| 0.9 50% LLDPE 50% HDPE OFM | 1.23 | 0.60 | 2.00 | 0.33 | 2.27 | 0.27 | 2.56 | 0.22 |
| 0.9 100% LLDPE OFM | 4.74 | 0.41 | 5.90 | 0.36 | 5.85 | 0.31 | 6.04 | 0.26 |

1. A dispenser for controlled release of a volatile material, the dispenser including a pair of walls sealed to atmosphere around a periphery of the dispenser and wherein the pair of walls are permeable to the volatile material and are separated from each other adjacent the periphery by a small gap of about 5 to 1000 microns, which small gap surrounds an internal reservoir containing the volatile material, the reservoir having a greater distance between the walls than the small gap, wherein the small gap is in open communication with the reservoir so that the volatile material is drawn over internal surfaces of the small gap by capillary action resulting from the close proximity of the internal surfaces to facilitate constant release of the volatile material from the dispenser.

2. The dispenser of claim 1 wherein the pair of walls are separated by a gap of 40 to 200 microns.

3. The dispenser of claim 1 wherein the pair of walls have a thickness of 250 to 2000 microns.

4. The dispenser of claim 3 wherein the pair of walls have a thickness of 700 to 1000 microns

5. The dispenser of claim 1 wherein the dispenser has a capacity of 50 to 20,000 microlitres.

6. The dispenser of claim 1 wherein the reservoir has a corrugated or ribbed internal surface to facilitate movement or spread of the volatile material located within the reservoir throughout an internal space of the dispenser which includes the reservoir and the small gap

7. The dispenser of claim 1 wherein the volatile material is selected from the group consisting of semiochemical, pheromone, kairomone, allomone, perfume, fragrance, insecticide, antibacterial agent, antifungal agent, plant growth regulator, plant hormone and essential oil.

8. The dispenser of claim 1 wherein the walls are made of a polymer.

9. The dispenser of claim 8 wherein the walls are made of ethylene vinyl acetate or polyethylene

10. The dispenser of claim 8 wherein the polymer comprises pigments, dyes or ultraviolet stabilizers.

11. The dispenser of claim 10 wherein the pigment is selected from the group consisting of carbon black, titanium dioxide, ferric oxide and zinc oxide.

12. The dispenser of claim 10 wherein the ultraviolet stabiliser is benzophenone or benzotriazile.

13. The dispenser of claim 1 further comprising a peripheral well about the periphery of the dispenser which prevents spread of the volatile material to the said periphery.

14. The dispenser of claim 1 wherein the volatile material may be admixed prior to insertion into the dispenser with an agent selected from the group consisting of anti-oxidant, ultraviolet stabilizer and diluent.

15. The dispenser of claim 1 attached or secured to an attachment or suspension means that allows the dispenser to be attached or suspended to a support structure.

16. The dispenser of claim 15 wherein the attachment or suspension means includes a body and a dispenser attachment means

17. The dispenser of claim 16 wherein the body or dispenser attachment means has a planar or sheet-like shape.

18. The dispenser of claim 16 wherein the attachment or suspension means includes a clip having a pair of resilient arms spaced from each other by a narrow slot.

19. The dispenser of claim 16 wherein the body is comprised of a rigid material.

20. The dispenser of claim 17 wherein the body is made from a rigid polymer.

21. The dispenser of claim 16 wherein the body comprises at least one dye or pigment which changes colour under prolonged exposure to sunlight.
